(19) United States
(12) Patent Application Publication
(10) Pub. No.: US 2010/0253475 A1
(43) Pub. Date: Oct. 7, 2010

(54) Device and method for monitoring a maintenance unit

(75) Inventor: Hermann Rosen, Kastanienbaum (CH)

Correspondence Address: GUDRUN E. HUCKETT DRAUDT, SCHUBERTSTR. 15A, WUPPERTAL, 42289, DE

(73) Assignee: ROSEN SWISS AG, Stans (CH)

(21) Appl. No.: 12/679,948

(22) PCT Filed: Sep. 18, 2008
(86) PCT No.: PCT/EP08/07787

§ 371 Date: Jun. 8, 2010

(30) Foreign Application Priority Data
Sep. 25, 2007 (DE) 10 2007 045 936.1

(51) Int. Cl. H04Q 5/22

(52) U.S. Cl. 340/10.1

(57) ABSTRACT

The invention relates to a method for monitoring a maintenance unit moving inside a pipeline, a state data signal generated by a first receiving and transmission unit due to a maintenance unit passing by being transmitted to at least one further receiving and transmission unit that is disposed at a distance along or in a pipeline, characterized in that the state data signal is provided with exact localization information by the first receiving and transmission unit, is routed via at least one further receiving and transmission unit in the direction of an interface device, and is supplied there to a SCADA system for analyzing the information that can be retrieved from the state data signal in quasi-real-time.

The present invention concerns a method for monitoring a maintenance unit moving in a pipeline, such as a cleaning scraper, wherein a status data signal generated by a first sending and receiving unit as a result of the maintenance device moving past it is transmitted to at least one additional sending and receiving unit arranged likewise on or along a pipeline at a distance from the first one. Furthermore, the invention concerns a device, which is configured in particular to carry out such a method and which comprises at least two sending and receiving units arranged at an interval on or next to a pipeline for the generating and transmitting of a status data signal generated as a result of a maintenance device moving in a pipeline.

Known devices for monitoring a maintenance device moved over large distances in a pipeline consist of sending and receiving units arranged on or preferably next to a pipeline, which upon movement past them of a maintenance device carried along by means of a fluid in the pipeline receive and/or generate a status data signal and relay it to a control site. Due to the large distances, the maintenance devices are in the pipeline for a long time and there is a need to better assess the progressing movement of these maintenance devices in the pipeline, for example, in order to better dispatch maintenance personnel to the stations for removal of the maintenance device from the pipeline. At the same time, the construction cost for such a monitoring system should be kept as low as possible.

It is therefore the problem of the present invention to improve a traditional method for the monitoring of a maintenance device moving in a pipeline and a device which can be used in particular for such a method and has at least two sending and receiving units.

The problem is solved by a method per claim 1 and a device per claim 10.

The status data signal is picked up by a first sending and receiving unit at the moment when the maintenance device, such as a cleaning scraper moved in a pipeline by the fluid present in the pipeline, comes near the sending and receiving unit or a sensor unit of this sensor and receiving unit. The sending and receiving unit has means for providing an exact localisation tag for the status data signal, for example, simple information as to the presence and possibly also a status of the maintenance device. This localisation tag can consist, for example, of a time provided by an internal clock, as well as the previously determined location of the sending and receiving unit. Other encoded information, especially for location and time, is also conceivable.

The status data signal is relayed on by the first sending and receiving unit via at least one additional sending and receiving unit in the direction of an interface unit (from one sending and receiving unit to another) until it can be picked up there. At the interface unit, the data signal is fed into a SCADA (Supervisory Control and Data Acquisition) System in quasi-real-time in order to evaluate the information which can be extracted from the status data signal. By a SCADA system is meant here an evaluation and control system for the pipeline in general. For example, it can be a system which enables access to the status data via the Internet. For example, the information obtained from the status data signal or the status data signal itself can be relayed to an inspection site of the SCADA system, where personnel assigned to check the maintenance device and the pipeline are informed directly as to the condition of the maintenance device. This inspection site can be positioned at the site of the interface unit or also at a site some distance from the pipeline. From the status data generated by the respective sending and receiving units in succession and due to the movement of the maintenance device past them, one can preferably assess the arrival time at an exit station and the speed.

Using the status data information, which is tied to the exact localisation tag, one can then fine tune a maintenance device having its own counting mechanism, such as a clockwork motion. A drift in the internal data of the maintenance device arising during the maintenance in the course of the maintenance interval can be eliminated from the data in this way.

Preferably, the status data signal is provided by the sending and receiving unit with a location and/or time signal of a global positioning system as the localisation tag, which is constantly available. In addition to known GPS signals, other alternative navigation signals can also be used for this, being emitted in the corresponding regions of the pipeline.

Preferably, the localisation tag is received and generated in the sending and receiving unit only upon or after detection of the status data signal by a source providing the localisation tag, in order to enable the most energy-saving operation of the sending and receiving unit.

For this, especially at times when no energy is available in the form of solar current, the sending and receiving unit can be provided with a rechargeable energy accumulator, for example, one which is charged during the daytime via a solar panel.

Advantageously, the status data signal is provided with information as to the origin of the status data signal by the first sending and receiving unit. In this way, a distinct code number is assigned to the status data signal, so that the other respective sending and receiving units can decide by means of corresponding, preferably electronic filter means whether to relay the status signal only to one particular assigned interface unit. The status data signal is thus transported further along the pipeline in a direction whose path is predetermined for the status data signal via the respective sending and receiving units in the direction of the interface unit.

Alternatively or in addition, the status data signal can be provided with a direction specifier for the transmission of the signal in a desired direction along the pipeline, for example, by use of a receiver code for the sending in the direction of the closest interface unit. The status data signal is then transported on in the direction where the desired interface unit is situated. In this case as well it is possible to predetermine the path taken by the status data to the evaluation unit or another inspection site. From a combination of sender or origin data and receiver code, in which case the receiver can be an interface unit or a sending and receiving unit lying in the direction of the desired interface unit, the latter can also decide how far to relay the status data signal.

Especially advantageous is the time-delayed double sending of a status data signal, which produces a redundant data set in regard to the data of the maintenance device, so as to make the system more failure-safe. In particular, the failure security of the system is substantially enhanced, especially in combination with a direction specifier for the transmission of the signal in a desired direction and double sending of the signal in two different directions along the pipeline. If one direction is blocked for the transmission of the status data signal, due to possibly malfunctioning sending and receiving units that are set up at intervals of several kilometres, the signal can still arrive at the desired interface unit by the other pathway.

Preferably, a first status data signal will be picked up by a sending and receiving unit, provided with an exact localisation tag, and then sent on in a direction with a first code. After this, the same signal will be sent on with an additional, different reception code to sending and receiving units located in another direction for the signal to be picked up by them. Now, if this second signal is picked up by a sending and receiving unit located in the wrong direction, the signal will not be further relayed onward. A transport of the first signal in the direction of the second signal is avoided in the same way.

So as to exert the least possible influence on pipelines lying in the ground or on the ground, the status data signal put out from the maintenance device is preferably picked up in noncontact fashion at the particular sending and receiving unit.

Preferably, the status data generated by the maintenance device moving past the sending and receiving units is used to calculate arrival times of the maintenance device, speeds, and/or reference data for the synchronisation of the data recorded in the maintenance device, preferably after an inspection. By means of this data, one can better plan the control of a pipeline, whose flow rate has to be reduced when using a maintenance device.

The problem is likewise solved by a device according to the preamble of claim 10, characterised in that the first sending and receiving unit is configured to supplement the status data signal with an exact localisation tag and the at least one additional sending and receiving unit to relay the status data signal generated by the first sending and receiving unit in the direction of an interface unit of the device for feeding the status data signal into a SCADA system. Such a device, which can be constructed with a plurality of sending and receiving units along a pipeline and only partially intervenes in existing SCADA systems, is much less prone to malfunction than a device in which the status data signal is fed at each sending and receiving unit along the pipeline into the SCADA system likewise extending along the pipeline. On the one hand, the construction expense is reduced, and on the other hand the central detection of the system is possible at a station which is present in any case.

Preferably, the sending and receiving unit is provided with a solar panel for the energy supply, which is arranged on a pole stuck into the ground next to the pipeline or otherwise fastened. Alternatively or in addition, another energy supply is also conceivable to produce an energy-independent sending and receiving unit, such as by using geothermal energy. With a rechargeable battery, a power supply is also possible for maintenance done on the pipeline at night.

The sending and receiving unit preferably contains a recording device for signals of a global positioning system, such as a GPS receiving unit.

Furthermore, the maintenance device preferably has at least one service interface, but especially preferably each sending and receiving unit has a corresponding interface, with which the proper functioning of the unit can be checked, and the means of the sending and receiving unit can be programmed for the desired relay behaviour of the unit during the set-up of the system.

Advantageously, the sending and receiving units have means for directional relaying of the status data signal. Thus, it is possible to optimise the sending process of the status data signal and the path travelled by it. Corresponding filter means can, for example, generate instructions for the further sending of the status data signal by microprocessor-controlled analysis of the status data signal and appropriate filtering out of the desired code for where the signal is to be sent from and in which direction.

Further benefits and details of the invention will be found in the following description of the figures.

The schematic representations in the figures show:

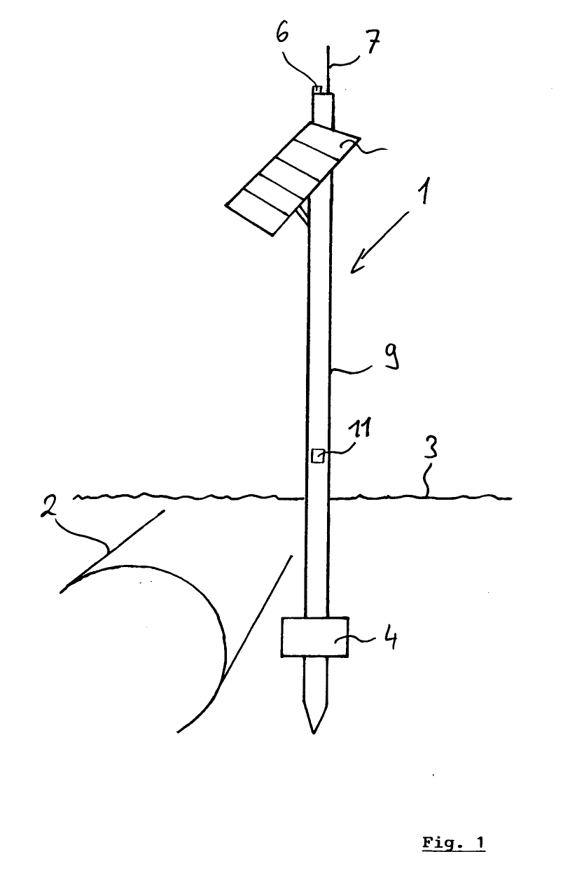

FIG. 1 a sending and receiving unit of a device according to the invention,

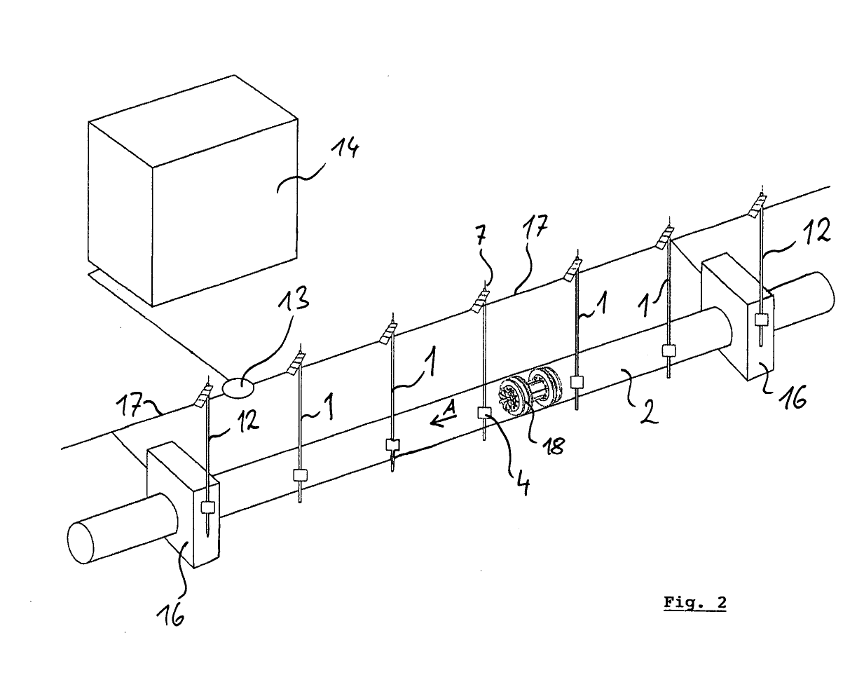

FIG. 2 a device according to the invention.

FIG. 1 shows a sending and receiving unit 1, which is arranged in the ground beneath a surface 3 next to a roughly indicated pipeline 2. Thanks to a maintenance device led through the pipeline 2, which arrives in the range of a sensor unit 4 of the sending and receiving unit 1, a status data signal is generated. This status data signal is either sent out directly by the maintenance device or passively generated by it, and the sensor unit 4 records the movement of the device past it.

A control unit of the sending and receiving unit, not otherwise shown, causes the simultaneous detection of position and time tags received via a GPS antenna 6 and co-ordinates them with the status data signal. The combined signal is now sent out via an antenna 7. Alternatively, the time synchronisation of the status data signals could also be done via a time signal provided by the SCADA system and possibly relayed to the individual sending and receiving units 1.

The energy supply of the sending and receiving unit 1 is provided by a solar panel 8, which is arranged on the mast 9 of the sending and receiving unit 1, stuck in the ground. An easily accessible service interface 11 is used to initialise and check or repair the sending and receiving unit when necessary. For example, one can use this service interface to set an internal clock or also a position specifier, which is saved in a corresponding memory of the unit 1 and transmitted along with the status data signal when it is sent out.

A sample embodiment of a device according to the invention per FIG. 2 comprises several sending and receiving units 1 arranged next to a pipeline 2, as well as two interface units 12, configured at least as a receiving unit. The interface units 12 each provide a link to a SCADA system 13, with which it is possible to monitor the respective terminal units 16 arranged on the pipeline, as well as the overall pipeline, from an inspection site 14.

The device according to the invention is connected at the terminal units 16 to the SCADA system 13 by means of the interface units 12. The sending and receiving units 1 are not connected to the lines 17 of the SCADA system 13. Instead, they run along the pipeline 2, independent of the device according to the invention.

The maintenance device 18, in this case a cleaning scraper, is led in the forward direction A through the pipeline 2. At the level of the closest sensor unit 4 in direction A in FIG. 2 and starting from the maintenance device 18, a status data signal is generated. Using the radio antenna 7 of the sending and receiving unit 1, the status data signal after being given the localisation tag obtained from the GPS receiver 6 is sent in direction A to the next closest terminal unit and the interface unit 12 arranged there. For this, the signal is given a receiver code, which specifies the direction of the signal along the pipeline (in direction A). The next sending and receiving unit 1 situated in direction A receives this signal and for its part initiates a relaying of the signal to the next receiving unit. This process repeats itself until the signal provided with a distinct receiver code arrives at the interface unit 12 located in direction A from the maintenance device 18.

The same process takes place with another data signal in time delay and with a correspondingly different code in the other direction (opposite direction A) along the pipeline to the receiving and interface unit 12 located there. In this way, the sending and receiving units 1 situated opposite the direction of forward movement A of the maintenance device will send the signal on to the interface unit 12 of the corresponding terminal unit 16. At the two terminal units 16, the status data signal is fed in via the interface units 12 into the SCADA system 13, after which the status data can be displayed at the inspection site 14.

What is claimed is:

1.-16. (canceled)

17. A method for monitoring a maintenance device moving in a pipeline, the method comprising the steps of:
generating a status data signal by a first sending and receiving unit when a maintenance device moves past the first sending and receiving unit;
combining the status data signal of the first sending and receiving unit with an exact localisation tag to a combined status data signal;
relaying the combined status data signal tag via at least one second sending and receiving unit, arranged on or along the pipeline at a distance from the first sending and receiving unit, toward an interface unit; and
feeding the combined status data signal into a SCADA system in quasi-real-time for evaluation of the information obtainable from the combined status data signal.

18. The method according to claim 17, wherein in the step of relaying the combined status data signal is picked up by the at least one second sending and receiving unit and sent on unchanged toward the interface unit.

19. The method according to claim 17, wherein the exact localization tag is a location and/or time signal of a global positioning system.

20. The method according to claim 17, comprising the step of generating the exact localisation tag only upon or directly after generation of the status data signal.

21. The method according to claim 17, comprising the step of providing the status data signal by the first sending and receiving unit with information as to the origin of the status data signal.

22. The method according to claim 17, comprising the step of providing the status data signal with a direction specifier for relaying the status data signal in a desired direction along the pipeline.

23. The method according to claim 17, comprising the step of sending the combined status data signal at least twice with a time delay by the first sending and receiving unit.

24. The method according to claim 17, comprising the step of picking up the combined status data signal in a noncontact fashion.

25. The method according to claim 17, comprising the step of calculating, by using status data of the combined status data signals generated by several of the first sending and receiving units, arrival times of the maintenance device, speeds, and/or reference data for the synchronisation of the data recorded in the maintenance device.

26. The method according to claim 25, wherein the step of calculating is carried out after an inspection of the pipeline.

27. A device, especially for carrying out a method according to claim 17, comprising:
a SCADA system;
an interface unit connected to the SCADA system;
a first sending and receiving unit configured to generate and transmit a combined status data signal provided with an exact localisation tag;
at least one second sending and receiving unit relaying the combined status data signal received from the first sending and receiving unit toward the interface unit for feeding the combined status data signal into the SCADA system.

28. . The device according to claim 27, wherein the first and second sending and receiving units each have an energy accumulator.

29. The device according to claim 28, wherein the energy accumulator is rechargeable.

30. The device according to claim 27, wherein the first and second sending and receiving units each have a solar panel as an energy supply.

31. The device according to claim 27, wherein the first and second sending and receiving units each have an independent energy supply.

32. The device according to claim 27, wherein the first and second sending and receiving units each have a recording device for signals of a global positioning system.

33. The device according to claim 27, comprising a service interface.

34. The device according to claim 27, wherein the first and second sending and receiving units each have means for directional relaying of the combined status data signal.
